(19) United States
(12) Patent Application Publication
(10) Pub. No.: US 2012/0209590 A1
(43) Pub. Date: Aug. 16, 2012

(54) TRANSLATED SENTENCE QUALITY ESTIMATION

(75) Inventors: Juan M. Huerta, Pleasantville, NY (US); Cheng Wu, Mount Kisco, NY (US)

(73) Assignee: INTERNATIONAL BUSINESS MACHINES CORPORATION, Armonk, NY (US)

(21) Appl. No.: 13/028,555

(22) Filed: Feb. 16, 2011

(51) Int. Cl. G06F 17/28

(52) U.S. Cl. 704/7

(57) ABSTRACT

A method, system, and computer readable storage medium including a computer readable program are provided. The method includes storing a set of sentences in a memory device. The method further includes receiving an input translated phrase and searching the set of sentences for a subset of sentences closest to the input translated phrase based on a set of respective distances to the sentences in the set with respect to the input translated phrase. The method also includes calculating and outputting a language model score for the subset of sentences based on a function of a subset of respective distances pertaining to the subset of sentences.

### BACKGROUND

1. Technical Field

The present invention generally relates to information retrieval and, more particularly, to translated sentence quality estimation.

2. Description of the Related Art

Currently used statistical language models are widely used in main computational linguistics tasks to compute the probability of a string of words p(w₁ . . . wᵢ).

To facilitate its computation, this probability is expressed as follows:

p(w₁ . . . wᵢ)=P(w₁)×P(w₂|w₁)× . . . ×P(wᵢ|w₁ . . . wᵢ₋₁).

Assuming that only the most immediate word history affects the probability of any given word, and focusing on a trigram language model, the following is obtained:

P(wᵢ|w₁ . . . wᵢ₋₁)≈P(wᵢ|wᵢ₋₂wᵢ₋₁).

This leads to the following:

$$P ( {w}_{1} … {w}_{i} ) \approx {\prod }_{k = 1 … i} p ( {w}_{k} \vert {w}_{k - 1} {w}_{k - 2} ) ,$$

Language models are typically applied in automatic speech recognition (ASR), machine translation (MT) and other tasks in which multiple hypotheses need to be rescored according to their likelihood (i.e., rank). In a smoothed backoff statistical language model (SLM), all the n-grams up to order n are computed and smoothed, and backoff probabilities are calculated. If new data is introduced or removed from the corpus, the whole model, the counts and weights would need to be recalculated. This is a major problem when large volumes of data are created and removed from the model pool.

### SUMMARY

According to an aspect of the present principles, a method is provided. The method includes storing a set of sentences in a memory device. The method further includes receiving an input translated phrase and searching the set of sentences for a subset of sentences closest to the input translated phrase based on a set of respective distances to the sentences in the set with respect to the input translated phrase. The method also includes calculating and outputting a language model score for the subset of sentences based on a function of a subset of respective distances pertaining to the subset of sentences.

According to another aspect of the present principles, there is provided a system. The system includes a memory device for storing a set of sentences. The system further includes a sentence retriever coupled to the memory device for receiving an input translated phrase and searching the set of sentences for a subset of sentences closest to the input translated phrase based on a set of respective distances to the sentences in the set with respect to the input translated phrase. The system also includes a quality score computer coupled to the sentence retriever for receiving the subset of sentences and a subset of respective distances pertaining to the subset of sentences, and calculating and outputting a language model score for the subset of sentences based on a function of the subset of respective distances.

According to yet another aspect of the present principles, a computer readable storage medium is provided which includes a computer readable program that, when executed on a computer causes the computer to perform the respective steps of the aforementioned method.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows a block diagram illustrating an exemplary computer processing system 100 to which the present principles may be applied, according to an embodiment of the present principles;

FIG. 2 shows an exemplary system 200 translated sentence quality estimation, according to an embodiment of the present principles;

FIG. 3 shows a flow diagram illustrating an exemplary method 300 for translation sentence quality estimation, according to an embodiment of the present principles;

FIG. 4 shows a flow diagram illustrating another exemplary method 400 for translation sentence quality estimation, according to an embodiment of the present principles; and

FIG. 5 shows an exemplary method 500 for stack-based search for translated sentence quality estimation, in accordance with an embodiment of the present principles.

### DETAILED DESCRIPTION OF PREFERRED EMBODIMENTS

As noted above, the present principles are directed to translated sentence quality estimation. In one or more embodiments of the present principles, we evaluate the quality of a translated sentence (also referred to herein as “the input translated query sentence” or simply “the query” in short) without the use of a reference sentence. It is to be appreciated that while an input translated query sentence is primarily described herein regarding one or more embodiments for purposes of illustration, the present principles are not so limited and may be used with respect to non-queries and non-sentences (i.e., phrases or sentence portions), while maintaining the spirit of the present principles.

In an embodiment, we use a large collection of sentences (a corpus), a sentence retriever configured to search for a set of the closest sentences to the query in the corpus, and a quality computer to compute the query translated sentence quality using a function of the distances of the query from the retrieved sentences.

In one or more embodiments, the query is the result of a machine translation process wherein an original query in a source language is translated into a target language and the resulting query in the target language (query) lacks a human produced reference sentence to which it could be compared against.

In an embodiment, we use a large collection of natural sentences (a corpus), a sentence retriever that retrieves the set of closest sentences from the corpus using string distance and given a translated query sentence, and a quality computer (scorer) that computes an estimate (score) of the statistical language model (SLM) probability of the translated query sentence using a mathematical regression. This estimate is intended to represent, through a quantitative score, the agreement, similarity, or feasibility of the translated query sentence given the corpus.

In another embodiment, the query translated sentence is the result of an automatic summarization system and the present principles segment and score fragments of the text separately and produces a combined final score for the whole paragraph.

As used herein, the phrase “translated sentence” refers to a sentence somehow modified, whether by machine translation and/or human translation, from one form (e.g., format, language, length, and so forth) to another.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer though any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

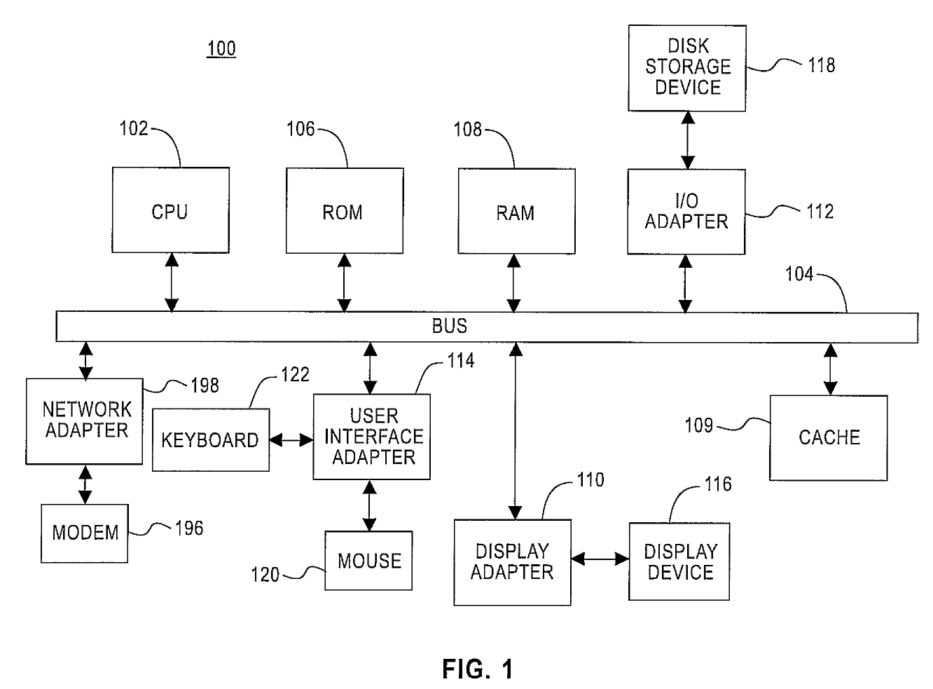

FIG. 1 shows a block diagram illustrating an exemplary computer processing system 100 to which the present principles may be applied, according to an embodiment of the present principles. The computer processing system 100 includes at least one processor (CPU) 102 operatively coupled to other components via a system bus 104. A read only memory (ROM) 106, a random access memory (RAM) 108, a display adapter 110, an I/O adapter 112, a user interface adapter 114, and a network adapter 198, are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

A (digital and/or analog, wired and/or wireless) modem 196 is operatively coupled to system bus 104 by network adapter 198.

Of course, the computer processing system 100 may also include other elements (not shown), including, but not limited to, a sound adapter and corresponding speaker(s), and so forth, and readily contemplated by one of skill in the art.

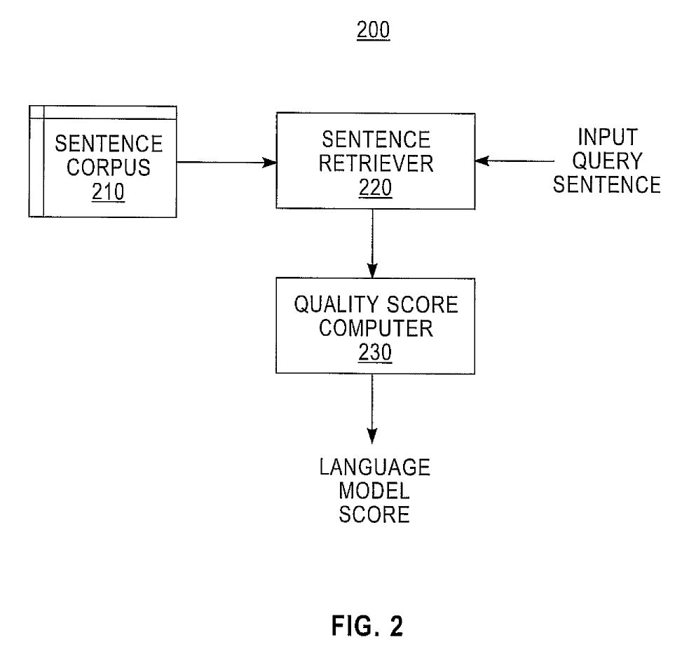

FIG. 2 shows an exemplary system 200 for translated sentence quality estimation, in accordance with an embodiment of the present principles. It is to be appreciated that system 200 may be used with respect to (input) translated query sentences, non-queries, and/or non-sentences (i.e., phrases or sentence portions), while maintaining the spirit of the present principles. The system 200 includes a storage medium 210 for storing a corpus of sentences, a sentence retriever 220, and quality score computer 230. The sentence retriever 220 has a first input connected in signal communication with an output of the storage medium 210, for accessing the sentences stored therein. The sentence retriever 220 also has a second (external) input for receiving a query translated sentence. The sentence retriever 220 has an output connected in signal communication with an input of the quality score computer 230. The quality score computer 230 has an (external) output for providing a score such as a language model score.

It is to be appreciated that system 200 may be implemented by a computer processing system such as computer processing system 100 shown and described with respect to FIG. 1. Moreover, it is to be appreciated that select elements of computer processing system 100 may be embodied in one or more elements of system 200. For example, a processor and requisite memory may be included in one or more elements of system 200, or may be distributed between one or more of such elements. In any event such requisite processing and memory hardware are used in any implementations of system 200, irrespective of which elements use and/or otherwise include the same. Given the teachings of the present principles provided herein, it is to be appreciated that these and other variations and implementations of system 200 are readily contemplated by one of skill in this and related arts, while maintaining the spirit of the present principles.

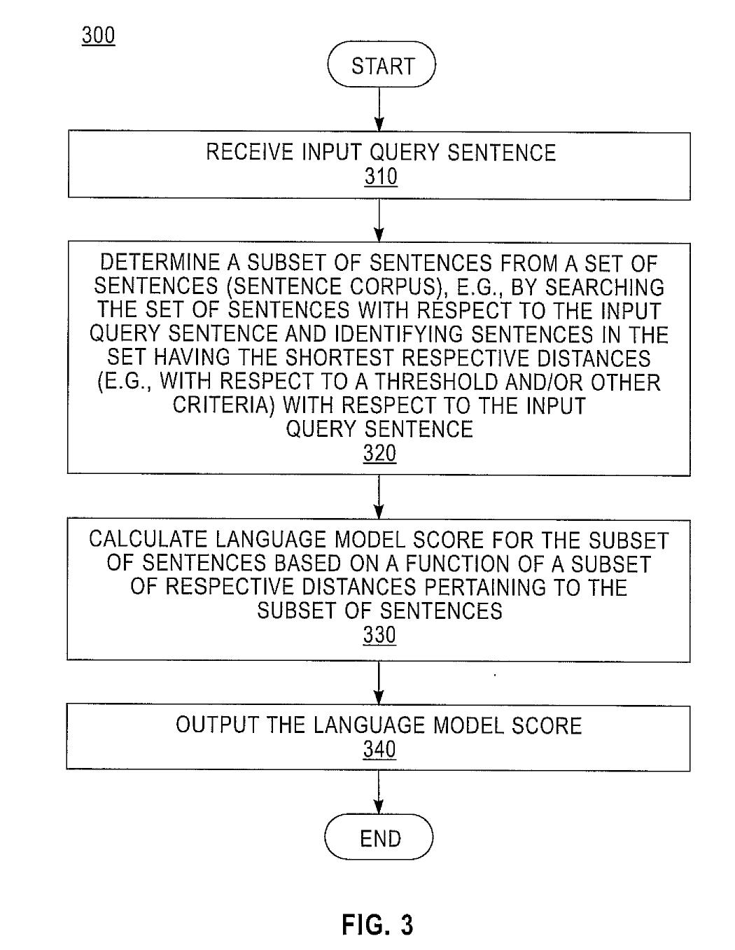

FIG. 3 shows a flow diagram illustrating an exemplary method 300 for translated sentence quality estimation. With respect to the method 300, we will refer to the sentence corpus (e.g., stored in storage medium 210 in FIG. 2) as a set of sentences. At step 310, an input translated query sentence is received. At step 320, a subset of sentences is determined from the set of sentences, where the sentences in the subset are closest to the input translated query sentence. Step 320 may involve, for example, searching the set of sentences with respect to the input translated query sentence and identifying sentences in the set having the shortest respective distances (for example, with respect to a threshold and/or other criteria) with respect to the input translated query sentence. At step 330, a language model score is calculated for the subset of sentences based on a function of a subset of respective distances pertaining to the subset of sentences. At step 340, the language model score (for the subset of sentences) is output. We note that the language model score may be a single score for the entire subset of sentences (for example, the mean or median of the scores, or the highest score from amongst all the scores for the sentences in the subset), or may be individual language model scores with each of the scores relating to a respective individual one of the sentences in the subset.

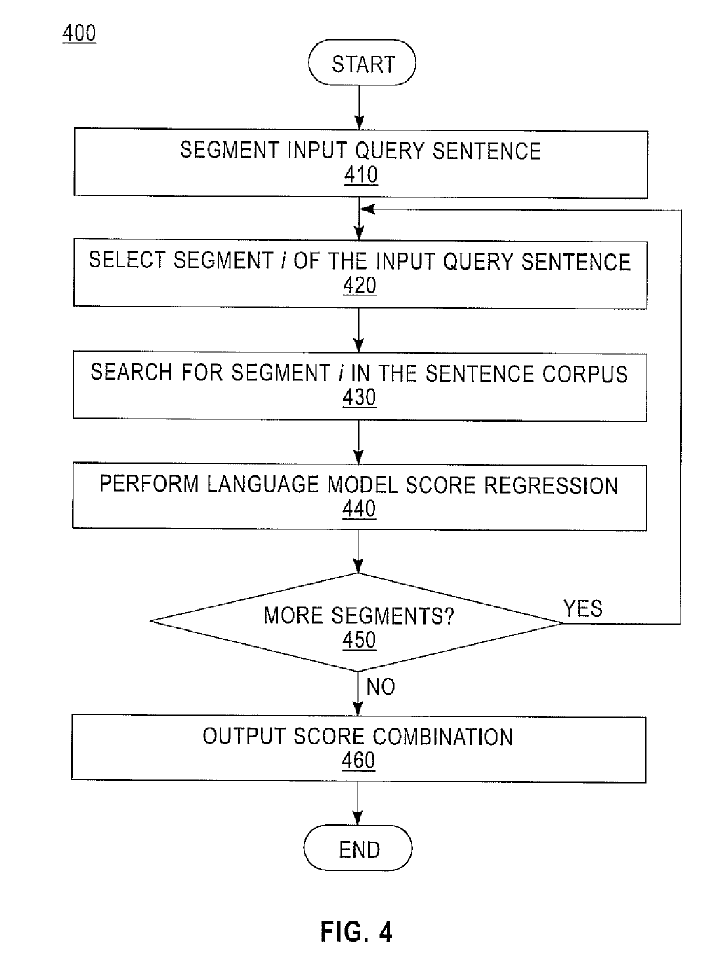

FIG. 4 shows a flow diagram illustrating another exemplary method 400 for translated sentence quality estimation. Method 400 differs from method 300 in that the input translated query sentence is segmented, and the resultant segments are evaluated against the sentences in the corpus. At step 410, an input translated query sentence is segmented. At step 420, segment i of the input translated query sentence is selected. At step 430, segment i is searched for in the corpus. At step 440, a language model score regression is performed. At step 440, it is determined whether or not there are any more segments (to be processed). If so, then the method returns to step 420 (to process the next segment). Otherwise, the method proceeds to step 460. At step 460, a quality score combination (i.e., a score resulting from all the processed segments) is output. The quality score combination can be the arithmetic mean of the scores of the segments. Alternatively, the geometric mean of the scores of the segment can be used. Yet as another alternative, respective logistic regressions of the individual scores of the segments in which an exponential function of a linear combination of the scores is applied can be used. Still as another alternative, a non-linear sigmoid function of the linear combination of the scores can be applied. Of course, while described in terms of alternatives, two or more of the preceding approaches can be combined in other embodiments, while maintaining the spirit of the present principles.

It is to be appreciated that method 300 and method 400 may be used with respect to translated query sentences, non-queries, and/or non-sentences (i.e., phrases or sentence portions) as inputs thereto, while maintaining the spirit of the present principles. Hence, in the case of method 400, for an input translated phrase, it is the input translated phrase itself that is segmented at step 410.

Thus, in accordance with the present principles, we introduce a new approach for judging and/or otherwise estimating the quality of a sentence. In one or more embodiments, the sentence is created or modified using automated methods (such as, for example, machine translation). Our approach is based on the computation of a quality score directly from a large collection of sentences (a corpus). The quality of a sentence currently being considered, i.e., an input translated query sentence, is based on a distance of that sentence with respect to the sentences in the sentence corpus. To that end, an index or other arrangement may be used to arrange the sentences (or portions thereof, such as, for example, but not limited to, sentence segments (one or more words), individual words, and even word segments), in the sentence corpus from which distance information can be derived with respect to the input translated query sentence.

We call our approach as employed in one or more embodiments the Information Retrieval Language Model (IR-LM). The Information Retrieval Language Model is a novel approach to language modeling motivated by domains (as represented by the sentence corpus described herein) with constantly changing large volumes of linguistic data. Our approach is based on information retrieval methods and constitutes a departure from the traditional statistical n-gram language modeling (SLM) approach. We believe the IR-LM is more adequate than SLM when: (a) language models need to be updated constantly; (b) very large volumes of data are constantly being generated; (c) it is possible and likely that the sentence we are trying to score has been observed in the data (albeit with small possible variations); and (d) assessing the data feasibility is desired instead of the frequentist likelihood, that is the scores provided by the statistical language model (SLM) which are proportional to the frequency with which a sentence or sentence segment occurs in the data.

Thus, in one or more embodiments, we estimate the quality of a sentence that was possibly created or modified using a function we call the IR-LM (Information Retrieval language model). Hence, to estimate the quality of a query our approach provides the query translated sentence as the input to the Information Retrieval language model.

The Information Retrieval language model approach can be considered to include two steps as follows. The first step is the identification of a set of matches from a corpus given a query translated sentence. The second step is the estimation of a likelihood-like value for the query.

Further regarding the first step, given a corpus C and a query translated sentence S, we identify the k-closest matching sentences in the corpus through an information retrieval approach. In one or more embodiments, we use a String Edit Distance (or a modified String Edit Distance more fully described herein below) as a score in the information retrieval process. The String Edit Distance is the number of operations required to transform one string (the input translated query sentence or portion thereof) to another string currently being compared there against (that is, a sentence or portion thereof from the sentence corpus).

In one or more embodiments, to efficiently carry out the search of the closest sentences in the corpus, we propose the use of an inverted index with word position information and a stack based search approach. In the stack based search approach, each term in the query sentence is considered in sequence. For each of these terms, the sentences that carry such terms are retrieved from the index. The placement of the term under consideration in each of these sentences (with each of such sentences individually referred to as a “hypothesis”), is compared against the placement of the same term in the query sentence. If the query sentence is consistent with the hypothesis, i.e., if the placement of a current term under consideration is consistent between the query sentence and the hypothesis sentence, then the hypothesis is included in a list of feasible hypotheses. This list is a last input, first output structure called a stack. Every time a new hypothesis is inserted in the stack, the whole stack is reorganized and consolidated in terms of score. This process is called a stack based search approach.

In an embodiment, the index that is formed from the sentence corpus may be an inverted index with word position information. An inverted index is an index structure in which for each word a list of all the occurrences thereof in the corpus is included. An inverted index with word position information (or also known as a positional index), specifies not only the sentences that carry the term but also the position in each sentence that each instance has in those sentences. The index may be generated, for example, using normalized model data and segmented model data when the sentences in the sentence corpus are segmented for use in determining distances and respective scores.

In an embodiment, we perform the following to generate a sentence score.
1. For a query translated sentence 5, order the terms in S in order of decreasing rarity.
2. For every term in S (ordered):
   2.a. Identify from the inverse index all the sentences that include this term.
   2.b. For every sentence that includes this term:
      2.b.1. If the sentence is not in the stack and there is space in the stack, append sentence to the stack.
      2.b.2. If the sentence is in the stack and the last observed term location in the query and in the model sentence are consistent with the current term's locations then update the evidence for this sentence.
      2.b.3. If sentence is not in the stack and there is no space in the stack, prune the low performing hypotheses and insert the current term.
      2.b.4. Otherwise, ignore.
3. Sort the stack by score (highest similitude at the beginning of the stack).
4. Take the score corresponding to the best match. This is the feasibility score (equivalent to the likelihood) produced by our approach.

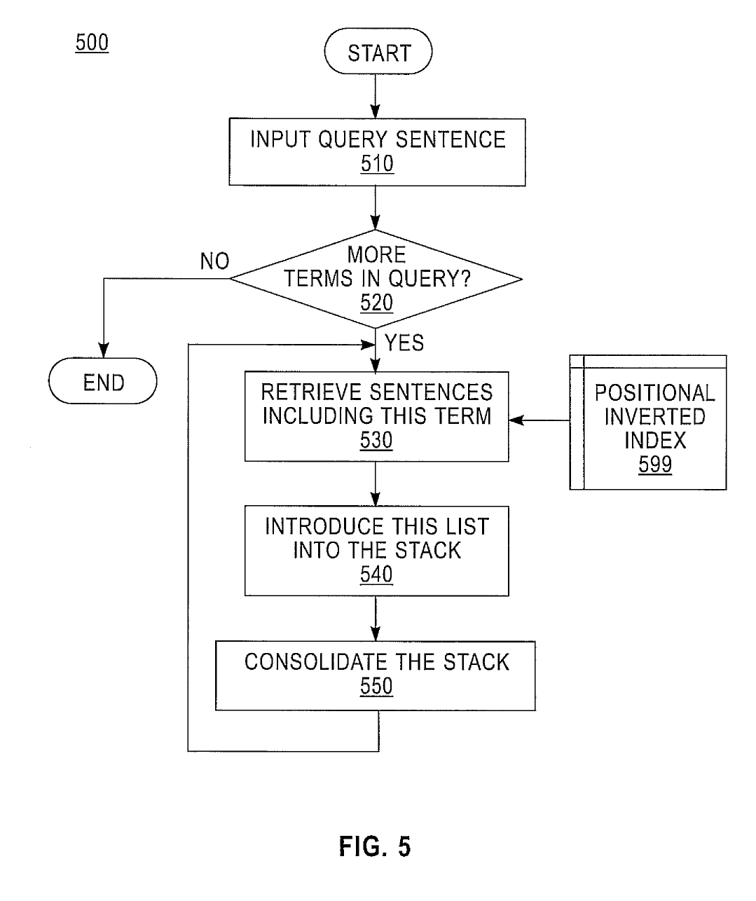

FIG. 5 shows an exemplary method 500 for stack-based search for translated sentence quality estimation, in accordance with an embodiment of the present principles. At step 510, the query sentence is input. At step 520, it is determined whether or not there are any more terms in the query sentence, with such determination made by sequential proceeding through each of the terms in the query sentence. If so, then the method proceeds to step 530. Otherwise, the method is terminated. At step 530, the (non-query) sentences that include the current term under consideration (from the query sentence) are retrieved from, for example, a positional inverted index 599. At step 540, the sentences having a position for the current term under consideration consistent with the position of that term in the query sentence are included in a list (of feasible hypotheses), and the list is introduced into the stack. At step 550, the stack is consolidated (in terms of scores, in view of the newly introduced list(s)), and the method returns to step 530.

A modification of the way the stack search algorithm computes the string edit distance SED can potentially allow queries to match local portions of long sentences (considering local insertions, deletions and substitutions) without any penalty for missing the non-local portion of the matching sentence. Specifically, this modification provides higher scores for words that are in the vicinity, high penalties for insertions, deletions and substitutions in these word clusters, and lower scores and penalties for words or errors falling in regions away from these word clusters. Of course, given the teachings of the present principles provided herein, this and other approaches to performing the search based on distance are readily contemplated by one of ordinary skill in the art, while maintaining the spirit of the present principles. That is, other arrangements of indexes or other structures may be used to represent the corpus, and other types of distance metrics besides SED may be used.

Further regarding the second step, in general, we would like to compute a likelihood-like value of the query translated sentence S through a function of the distances (or alternatively, similarity scores) of the query translated sentence S to the top k-hypotheses in the sentence corpus. However, for now we focus on the more particular problem of ranking multiple sentences in order of matching scores which, while not directly producing likelihood estimates, will allow us to implement n-best rescoring. Specifically, our ranking is based on the level of matching between each sentence to be ranked and its best matching hypothesis in the corpus.

In this case, integrating and removing data from the model simply involves adding to or pruning from the index which are generally simpler functions than n-gram re-estimation.

There is an important fundamental difference between the classic n-gram SLM approach and our approach. The n-gram approach says that a sentence S1 is more likely than another sentence S2 given a language model if the n-grams of S1 have been observed more times than the n-grams of S2. Our approach, on the other hand, says that a sentence S1 is more likely than S2 if the closest match to S1 in C resembles S1 better than the closest match of S2 resembles S2 regardless of how many times these sentences have been observed.

The IR-LM can be beneficial when the language model needs to be updated with added and/or removed data. This is particularly important in social data where new content is constantly being generated. Our approach also introduces a different interpretation of the concept of likelihood of a sentence. That is, instead of assuming the frequentist assumption underlying n-gram models, it is based on sentence feasibility which, in turn, is based on the closest segment similarity.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method comprising:
storing a set of sentences in a memory device;
receiving an input translated phrase and searching the set of sentences for a subset of sentences closest to the input translated phrase based on a set of respective distances to the sentences in the set with respect to the input translated phrase; and
calculating and outputting a language model score for the subset of sentences based on a function of a subset of respective distances pertaining to the subset of sentences.

2. The method of claim 1, wherein the sentence retriever searches for the subset of sentences using respective string edit distances to the sentences in the set with respect to the input translated phrase.

3. The method of claim 1, wherein the language model score is calculated to mimic a probability of the input translated phrase given the set of sentences.

4. The method of claim 1, wherein the set of sentences is sub-sampled to provide a sub-sampled set of sentences from which the subset of sentences is determined by said sentence retriever.

5. The method of claim 1, wherein the input translated phrase is a machine translation engine output.

6. The method of claim 1, wherein the input translated phrase is a result of an automated process.

7. The method of claim 1, wherein the input translated phrase is a result of a human post-editing a machine translation engine output.

8. The method of claim 1, wherein the text of the input translated phrase is segmented to obtain a plurality of segments, and wherein the plurality of segments are used in place of the sentences in the set to determine a group of respective distances from the plurality of segments with respect to the input translated phrase, and wherein the language model score is calculated with respect to the group of respective distances.

9. The method of claim 8, wherein a final language model score that is output is a function of respective scores of the individual segments in the plurality of segments.

10. The method of claim 1, wherein the language model score comprises one of a single score for all of the sentences in the subset and a plurality of individual scores, with each of the plurality of individual scores corresponding to a respective one of the sentences in the subset.

11. A system comprising:
a memory device for storing a set of sentences;
a sentence retriever coupled to said memory device for receiving an input translated phrase and searching the set of sentences for a subset of sentences closest to the input translated phrase based on a set of respective distances to the sentences in the set with respect to the input translated phrase; and
a quality score computer coupled to said sentence retriever for receiving the subset of sentences and a subset of respective distances pertaining to the subset of sentences, and calculating and outputting a language model score for the subset of sentences based on a function of the subset of respective distances.

12. The system of claim 11, wherein the sentence retriever searches for the subset of sentences using respective string edit distances to the sentences in the set with respect to the input translated phrase.

13. The system of claim 11, wherein the language model score is calculated to mimic a probability of the input translated phrase given the set of sentences.

14. The system of claim 11, wherein the set of sentences is sub-sampled to provide a sub-sampled set of sentences from which the subset of sentences is determined by said sentence retriever.

15. The system of claim 11, wherein the input translated phrase is a machine translation engine output or a result of a human post-editing the machine translation engine output.

16. The system of claim 11, wherein the input translated phrase is a result of an automated process.

17. The system of claim 11, wherein the text of the input translated phrase is segmented to obtain a plurality of segments, and wherein the plurality of segments are used in place of the sentences in the set to determine a group of respective distances from the plurality of segments with respect to the input translated phrase, and wherein the language model score is calculated with respect to the group of respective distances.

18. The system of claim 17, wherein a final language model score that is output from said quality computer is a function of respective scores of the individual segments in the plurality of segments.

19. The system of claim 11, wherein the language model score comprises one of a single score for all of the sentences in the subset and a plurality of individual scores, with each of the plurality of individual scores corresponding to a respective one of the sentences in the subset.

20. A computer readable storage medium comprising a computer readable program, wherein the computer readable program when executed on a computer causes the computer to perform the following:
storing a set of sentences in a memory device;
receiving an input translated phrase and searching the set of sentences for a subset of sentences closest to the input translated phrase based on a set of respective distances to the sentences in the set with respect to the input translated phrase; and
calculating and outputting a language model score for the subset of sentences based on a function of a subset of respective distances pertaining to the subset of sentences.
